(19) United States
(12) Patent Application Publication
(10) Pub. No.: US 2026/0027396 A1
(43) Pub. Date: Jan. 29, 2026

(54) BATTERY FIRE PREVENTION DEVICE USING CATALYTIC CONVERSION WITH AN OXYGEN SUPPLY

(71) Applicant: GM Global Technology Operations LLC, Detroit, MI (US)

(72) Inventors: Seunghwan Keum, Northville, MI (US); Ronald O. Grover, JR., Northville, MI (US); Jian Gao, Auburn Hills, MI (US); Gongshin Qi, Troy, MI (US); Lei Wang, Rochester Hills, MI (US); Mingjie Tu, Sterling Heights, MI (US); Ryan Patrick Hickey, Austin, TX (US); Yangbing Zeng, Troy, MI (US)

(21) Appl. No.: 18/785,564

(22) Filed: Jul. 26, 2024

(51) Int. Cl. A62C 3/16; F01N 3/022; F01N 3/033

(52) U.S. Cl. CPC A62C 3/16; F01N 3/0222; F01N 3/033

(57) ABSTRACT

A fire prevention device is provided. The fire prevention device includes a particulate filter, a mixing chamber, a converter, and a gas scrubber. The particulate filter is configured to receive flammable gas from a battery pack housing and to filter ejecta from the flammable gas exhausted from the battery pack housing. The mixing chamber is fluidly coupled with and configured to receive the flammable gas from the particulate filter. Additionally, the mixing chamber is fluidly coupled with an oxygen supply. The converter is fluidly coupled with and configured to receive the flammable gas and oxygen from the mixing chamber. The converter includes an oxidation catalyst that converts the flammable gas to an inert gas by a chemical reaction. The gas scrubber is fluidly coupled with the converter. The fire prevention device is coupled to the battery pack housing.

### INTRODUCTION

The present disclosure relates to a battery pack assembly, and more particularly to battery pack assembly having a fire prevention device.

Rechargeable energy storage systems (RESS) typically include one or more battery pack assemblies having battery cells that are rechargeable. The rechargeable battery cells are useful in various modern technical applications such as electronic devices, electric bicycles, hybrid cars, electric cars, and the like.

Battery cells may undergo unfavorable thermal runaway, where the heat generated by one of the battery cells becomes greater than the ability of the battery pack assembly to dissipate the heat to its surroundings. This can result in unfavorable temperature increases in the battery pack assembly. Because of the temperature increases, thermal runaway can occur, for example, when the battery is short-circuited or damaged. The thermal runaway phenomenon in one battery cell in the battery pack assembly may trigger corresponding unfavorable thermal events in adjacent battery cells resulting in thermal runaway propagation. When a battery undergoes thermal runaway, highly flammable gas is generated creating a fire risk.

While prior art methods and systems attempt to reduce risk of thermal propagation and fire risk within a battery and may achieve their particular purpose, a need still exists for a new and improved process for reducing battery fire risk.

### SUMMARY

According to several aspects of the present disclosure, a fire prevention device is provided. The fire prevention device includes a particulate filter, a mixing chamber, a converter, and a gas scrubber. The particulate filter is configured to receive flammable gas from a battery pack housing and to filter ejecta from the flammable gas exhausted from the battery pack housing. The mixing chamber is fluidly coupled with and configured to receive the flammable gas from the particulate filter. Additionally, the mixing chamber is fluidly coupled with an oxygen supply. The converter is fluidly coupled with and configured to receive the flammable gas and oxygen from the mixing chamber. The converter includes an oxidation catalyst that converts the flammable gas to an inert gas by a chemical reaction. The gas scrubber is fluidly coupled with the converter. The fire prevention device is coupled to the battery pack housing.

In accordance with another aspect of the disclosure, the fire prevention device includes a particulate filter with a plurality of channels having channel walls. Each channel wall includes a porous material.

In accordance with another aspect of the disclosure, the fire prevention device includes the plurality of channels closed at one of an inlet of the particulate filter or an outlet of the particulate filter. Flammable gas entering a channel closed at the outlet of the particulate filter must flow through a porous wall into a channel closed at the inlet of the particulate filter.

In accordance with another aspect of the disclosure, the fire prevention device includes the plurality of channels having a diameter or a width of about one centimeter.

In accordance with another aspect of the disclosure, the fire prevention device includes an oxygen supply including a chemical oxygen generator (COG).

In accordance with another aspect of the disclosure, the fire prevention device includes a chemical oxygen generator (COG) with at least one of a chlorate of alkali metals.

In accordance with another aspect of the disclosure, the fire prevention device has an oxygen supply including an oxygen tank.

In accordance with another aspect of the disclosure, the fire prevention device has an oxygen supply including an air multiplier device that draws ambient air using a Coanda effect.

In accordance with another aspect of the disclosure, the fire prevention device includes an oxygen supply having an active device that blows and provides ambient air to the mixing chamber.

In accordance with another aspect of the disclosure, the fire prevention device has a converter including a surface that is a monolith block with a honeycomb structure.

In accordance with another aspect of the disclosure, the fire prevention device has a converter including a packed bed reactor.

In accordance with another aspect of the disclosure, the fire prevention device has an oxidation catalyst coated on at least a portion of the converter.

In accordance with another aspect of the disclosure, the fire prevention device has an oxidation catalyst having a three-way catalyst including at least one of platinum or palladium.

In accordance with another aspect of the disclosure, the fire prevention device has an oxidation catalyst comprising hopcalite.

According to several aspects of the present disclosure, a battery pack assembly is provided. The battery pack assembly includes a fire prevention device coupled to a battery pack housing. The fire prevention device includes a particulate filter, a converter, and a gas scrubber. The particulate filter is configured to receive flammable gas from the battery pack housing and filter ejecta from the flammable gas The converter is fluidly coupled with and configured to receive the flammable gas from the particulate filter. The converter includes an oxygen storage catalyst (OSC) that releases oxygen and is an oxidation catalyst that converts the flammable gas to an inert gas by a chemical reaction. The gas scrubber is fluidly coupled with the converter.

In accordance with another aspect of the disclosure, the battery pack assembly has a particulate filter including a plurality of channels having channel walls. Each channel wall includes a porous material.

In accordance with another aspect of the disclosure, the battery pack assembly has an oxygen storage catalyst (OSC) including at least one of cerium oxide, perovskite, or hopcalite.

In accordance with another aspect of the disclosure, the battery pack assembly has an oxygen storage catalyst (OSC) including about 30 grams of cerium oxide.

In accordance with another aspect of the disclosure, the battery pack assembly has an oxygen storage catalyst (OSC) applied to at least a portion of the converter.

According to several aspects of the present disclosure, a battery pack assembly is provided. The battery pack assembly includes a fire prevention device coupled to a battery pack housing. The first prevention device includes a particulate filter, a mixing chamber, a converter, and a gas scrubber. The particulate filter is configured to receive flammable gas from the battery pack housing and to filter ejecta from the flammable gas. The particulate filter includes a plurality of channels having channel walls, and each channel wall includes a porous material through which the ejecta cannot pass. The mixing chamber is fluidly coupled with and configured to receive the flammable gas from the particulate filter. The mixing chamber is fluidly coupled with a dedicated oxygen supply that supplies oxygen to the flammable gas for converting the flammable gas to an inert gas. The converter is fluidly coupled with and configured to receive the flammable gas from the mixing chamber. The converter includes an oxidation catalyst that converts the flammable gas to an inert gas by a chemical reaction. The converter is about 100 millimeters in diameter and about 120 millimeters in length, and the oxidation catalyst has a honeycomb structure with 20 mol/m³ catalyst loading. The gas scrubber is fluidly coupled to the converter.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle including a battery pack assembly having a plurality of battery cells, in accordance with the present disclosure.

FIG. 2 is a schematic view illustrating a fire prevention device that fluidly and mechanically couples to a pack vent of the battery pack assembly shown in FIG. 1, in accordance with the present disclosure.

FIG. 3 is a cross-section view of a particulate filter included with the fire prevention device shown in FIG. 2, in accordance with the present disclosure.

FIG. 4 is a schematic view illustrating a fire prevention device having an oxygen supply including an oxygen storage catalyst disposed within a converter of the fire prevention device, in accordance with the present disclosure.

FIG. 5 is a schematic view illustrating a fire prevention device having an oxygen supply including a chemical oxygen generator disposed within a mixing chamber of the fire prevention device, in accordance with the present disclosure.

FIG. 6 is a schematic view illustrating a fire prevention device having an oxygen supply including an oxygen tank coupled to the mixing chamber of the fire prevention device, in accordance with the present disclosure.

FIG. 7 is a schematic view illustrating a fire prevention device having an oxygen supply including an air multiplier device fluidly coupled to the mixing chamber of the fire prevention device, in accordance with the present disclosure.

FIG. 8 is a schematic view illustrating a fire prevention device having an oxygen supply including an active oxygen supply device fluidly coupled to the mixing chamber of the fire prevention device, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

When a battery undergoes thermal runaway, highly flammable gas is generated. The flammable gas can include carbon monoxide (CO), hydrogen H₂, and other hydrocarbons, for example ethylene. The battery pack assembly and fire prevention device disclosed herein prevent a fire due to ignition of the flammable gases produced by thermal propagation by converting the flammable gas into an inert gas using a controlled reaction over a catalyst. A dedicated oxygen supply is incorporated into the fire prevention device to provide necessary oxygen for the chemical reaction. Additionally, a particle filter is added to the fire prevention device to remove hot ejecta, which may cause ignition.

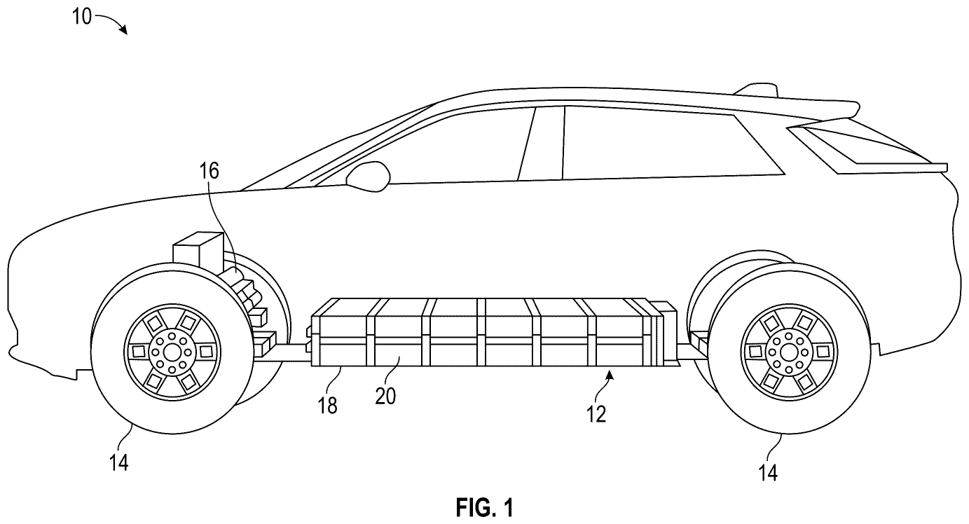

Referring to FIG. 1, a perspective view of a vehicle 10 having a battery pack assembly 12 is illustrated, in accordance with the present disclosure. The battery pack assembly 12 is illustrated with an exemplary vehicle 10. The vehicle 10 is an electric vehicle or hybrid vehicle having wheels 14 driven by electric motors/inverters 16. The electric motors/inverters 16 receive power from the battery pack assembly 12. While the vehicle 10 is illustrated as a passenger road vehicle, it should be appreciated that the battery pack assembly 12 may be used with various other types of vehicles. For example, the battery pack assembly 12 may be used in nautical vehicles, such as boats, or aeronautical vehicles, such as drones or passenger airplanes. Moreover, the battery pack assembly 12 may be used as a stationary power source separate and independent from a vehicle. Battery pack assembly 12 includes a case or housing 18 for supporting a plurality of battery cells 20. In an example, the battery pack 12 may have fifty or more battery cells 20.

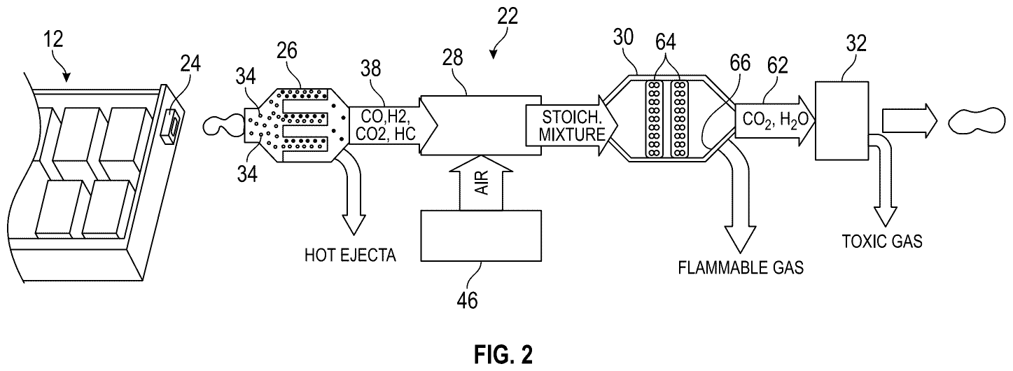

Referring now to FIG. 2, a schematic view of a fire prevention device 22 fluidly coupled to a pack vent 24 of the battery pack assembly 12 is illustrated, in accordance with the present disclosure. In an event of thermal runaway of the battery cells 20 within the battery pack assembly 12, the battery cells 20 may reach temperatures of up to 800° C. or hotter, and highly flammable gas may be generated, which may result in a battery pack fire, in some cases. The fire prevention device 22 functions to prevent a battery pack fire by converting the flammable gas into an inert gas using a controlled reaction over a catalyst within the fire prevention device 22. The fire prevention device 22 is mechanically coupled to the pack vent 24, which is disposed as a portion of the housing 18. The fire prevention device 22 includes a particulate filter 26, a mixing chamber 28, a converter 30, and a gas scrubber 32.

Referring still to FIG. 2, the particulate filter 26 couples to the housing 18 of the battery pack assembly 12. As the flammable gas is exhausted from the battery pack assembly 12 during thermal runaway, the flammable gas includes ejecta 34. The ejecta 34, which is hot and pressurized, can cause significant damage to components within the both the battery pack assembly 12 and the fire prevention device 22 and may serve as an ignition source. The particulate filter 26 is configured to filter and remove the ejecta 34 from the flammable gas before the flammable gas reaches the other components of the fire prevention device 22.

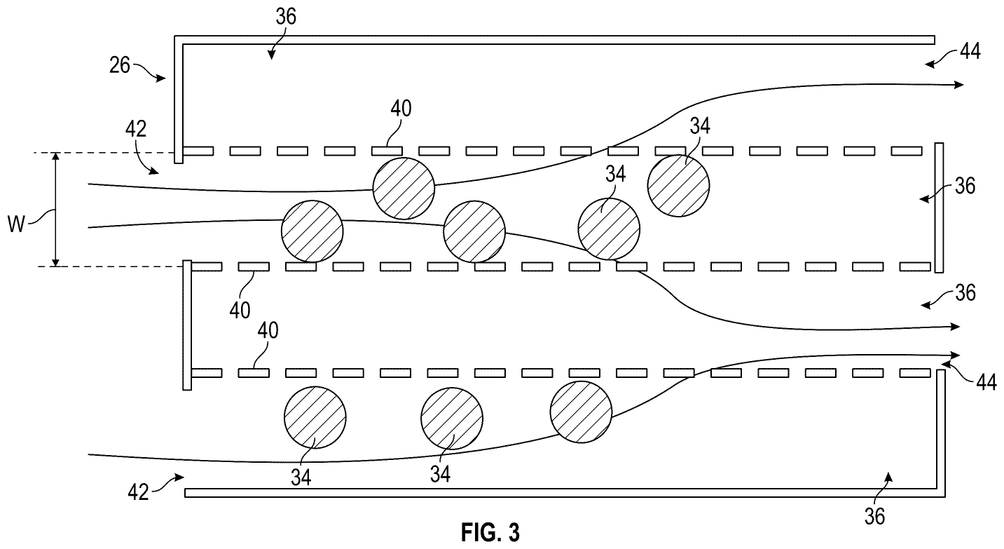

Referring now to FIG. 3, the particulate filter 26 includes a plurality of channels 36 for directing the flammable gas 38. The channels 36 include channel walls 40, which may be formed of a porous material. Each channel 36 is either closed or open at a channel inlet 42 or a channel outlet 44 so that flammable gas entering a channel 36 having an open channel inlet 42 and a closed channel outlet 44 must flow through the porous channel walls to a channel 36 with a closed channel inlet 42 and an open channel outlet 44. The porous channel walls 40 allow the flammable gas to pass but trap the ejecta 34 in the flammable gas, thus filtering and trapping the ejecta 34 within the particulate filter 26. In an example, a width W of each channel 36 is about 1 centimeter (cm) or less, which functions to block the ejecta 34 from passing through the channel walls 40. It will be appreciated that the channel 36 may include other widths W (e.g., 0.8 cm, 0.9 cm, 1.1 cm, 1.2 cm, and so forth).

Referring again to FIG. 2, the mixing chamber 28 is fluidly and mechanically coupled with the particulate filter 26 and receives the ejecta-free flammable gas from the particulate filter 26. The mixing chamber 28 includes and/or receives oxygen from an oxygen supply 46 disposed upstream of and/or within the converter 30 (shown upstream in FIG. 2). The flammable gas 38 received by the mixing chamber 28 from the particulate filter 26 includes very little or no oxygen. However, oxygen is necessary for catalytic oxidation within the converter 30 of the flammable gas to inert gas. When the oxygen supply 46 is upstream of the mixing chamber 28, the mixing chamber 28 receives oxygen and/or air from the oxygen supply 46 and mixes the oxygen with the flammable gas.

The mixing chamber 28 can include a variety of containers configured for mixing the flammable gas with the oxygen. For example, the mixing chamber 28 may include a steel or metal container. The mixing chamber 28 may include at least one baffle within or may include no baffles. It will be appreciated that the mixing chamber 28 may include a variety of materials and/or configurations that are suitable for mixing the flammable gas received from the particulate filter 26 and the oxygen from the oxygen supply 46.

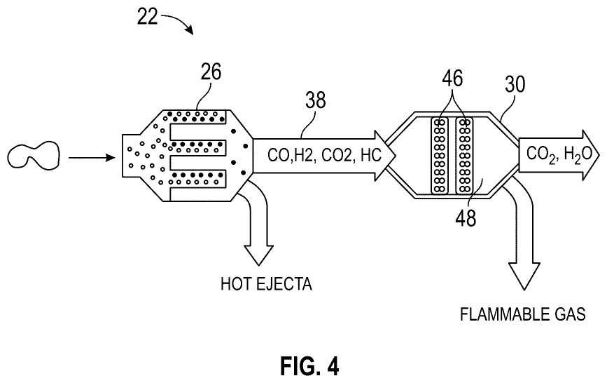

In one example illustrated in FIG. 4, the oxygen supply 46 is an oxygen storage catalyst (OSC) disposed within the converter 30. In this example, the mixing chamber 28 is not necessary, and the converter 30 is coupled directly to and receives the flammable gas from the particulate filter 26. The OSC is mixed with the oxygen catalyst in the converter 30 and is applied to a body 48 of the converter 30. The OSC releases oxygen as the flammable gas enters and passes through the converter 30. Some examples of a suitable OSC material include cerium oxide, perovskite, and/or hopcalite. When cerium oxide is used, and to treat the flammable gas per amp-hour battery capacity, about 30 grams of cerium oxide is needed. In this context, the term “about” is known to those skilled in the art. Alternatively, the term “about” may be read to mean plus or minus 0.5 grams.

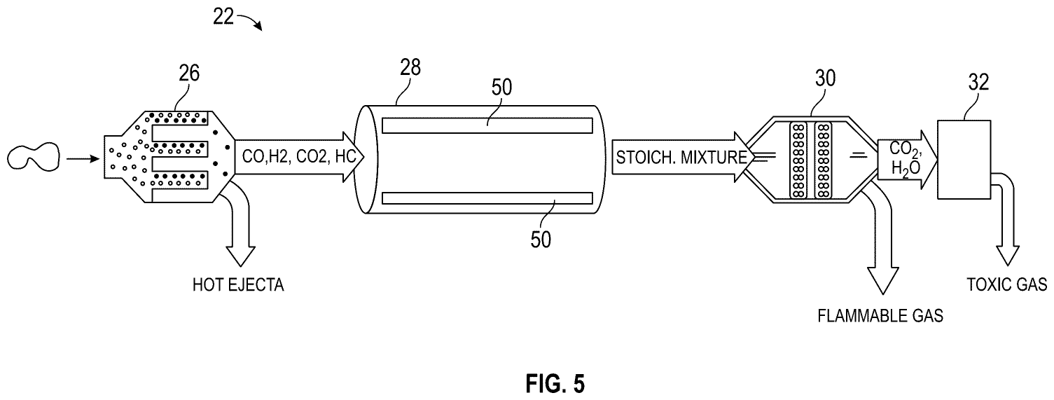

In another example illustrated in FIG. 5, the oxygen supply 46 is a chemical oxygen generator (COG) 50 disposed within the mixing chamber 28. The COG 50 releases oxygen at a high temperature but does not function as an oxidation catalyst. One example of a COG material includes chlorates of alkali metals, for example sodium perchlorate (NaClO₄). When using a COG 50 as the oxygen supply 46, the COG 50 may provide more oxygen when compared to a same mass of an OSC. In an example, when treating the flammable gas per ampere-hour capacity, about 10 grams of COG material may provide an adequate amount of oxygen to the mixing chamber 28 and the converter 30. In this context, the term “about” is known to those skilled in the art. Alternatively, the term “about” may be read to mean plus or minus 0.5 grams.

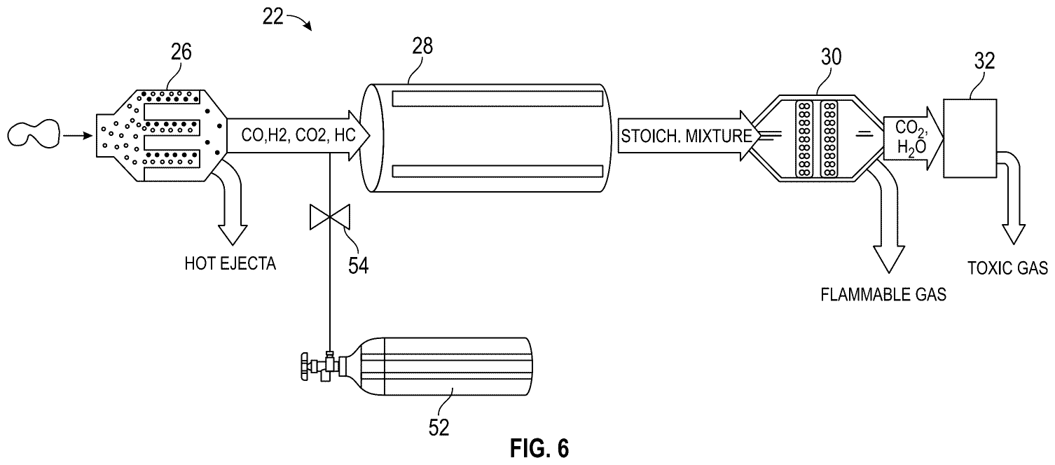

In another example illustrated in FIG. 6, the oxygen supply 46 is an oxygen tank 52 fluidly and mechanically coupled to the mixing chamber 28 and/or the converter 30. The oxygen tank 52 is coupled to the mixing chamber 28 and provides the oxygen upstream of the mixing chamber 28. A valve 54 may be disposed between the oxygen tank 52 and the mixing chamber 28. When the oxygen supply 46 is coupled to the converter 30, a valve may be disposed between the oxygen supply 46 and the converter 30. The oxygen tank 52 is configured to contain a suitable supply of oxygen (e.g., compressed oxygen) to facilitate an oxidation reaction in the converter 30.

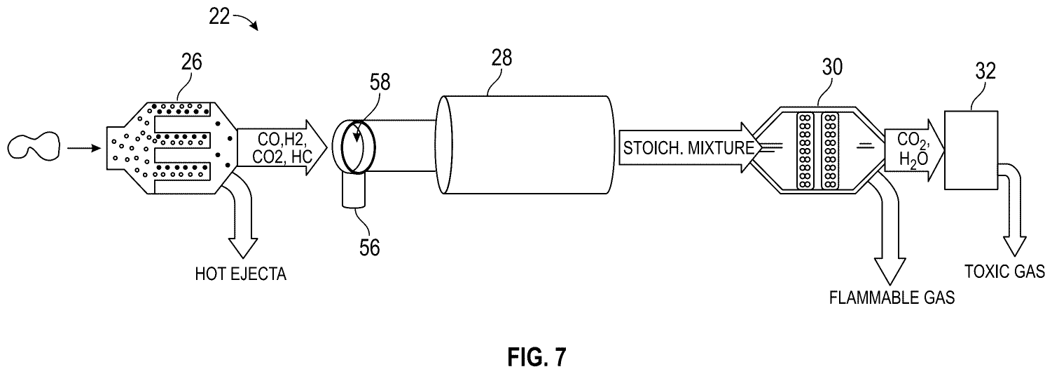

In another example illustrated in FIG. 7, the oxygen supply 46 includes an air multiplier device 56, which passively provides oxygen to the mixing chamber 28. The air multiplier device 56 draws ambient air using the Coanda effect. When using the Coanda effect, the flammable gas flows through an orifice 58 of the air multiplier device 56. As the flammable gas flows through and emerges from the orifice 58, the flammable gas tends to follow the surface of the air multiplier device 56 and entrains gas (ambient air) from its surroundings creating a region of lower pressure. The additional gas includes air and/or oxygen, which is provided to the mixing chamber 28 and the converter 30.

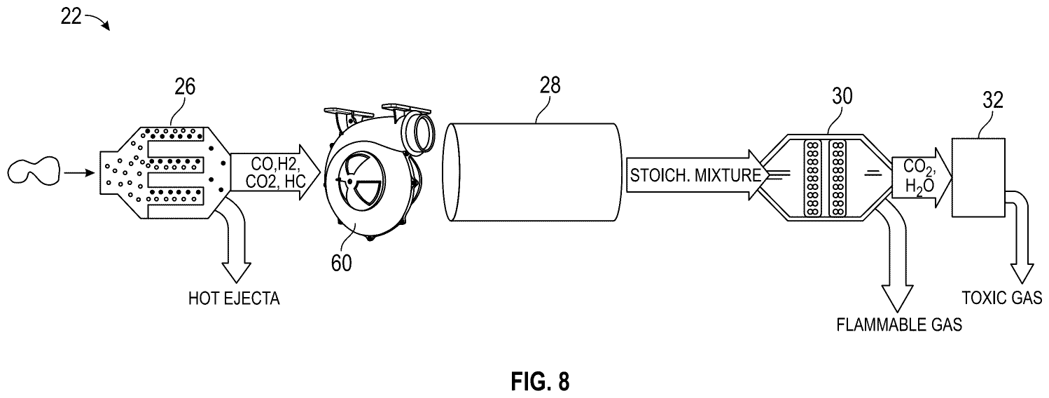

In another example, and as illustrated in FIG. 8, the oxygen supply 46 includes an active oxygen supply device 60. The active oxygen supply device 60 is fluidly coupled to the mixing chamber 28 and/or the converter 30. The active oxygen supply device 60 actively blows and/or provides ambient air to the mixing chamber 28 and/or the converter 30 to be mixed with the flammable gas. Some examples of an active oxygen supply device 60 include a fan, a blower, and an air pump.

Referring again to FIG. 2, the converter 30 is downstream from and fluidly and mechanically coupled to the mixing chamber 28 and/or the particulate filter 26. The converter 30 includes a catalyst 64 that converts the flammable gas to an inert gas by a chemical reaction. The catalyst 64 in the converter 30 catalyzes a redox reaction transforming flammable and toxic gas (e.g., carbon monoxide (CO), hydrogen gas (H₂), unburned hydrocarbons (HC)) from the battery pack assembly 12 into inert and less harmful gases (e.g., carbon dioxide (CO₂), water (H₂O)). Additionally, the catalyst 64 may catalyze oxides of nitrogen (NOx).

In an example, the converter 30 includes a catalyst 64 including a three-way catalyst (TWC), often used in controlling emissions from positive ignition engines, such as gasoline engines, but also the flammable gas generated by battery thermal runaway. The TWC converts unburned hydrocarbons (HC), carbon monoxide (CO), and nitrogen oxide (NOx) into the inert gas 62. The TWC may include platinum, rhodium, and/or palladium as the catalyst. When using a TWC, the HC and CO are oxidized by the supplied oxygen to form H₂O and CO₂, while any NOx is reduced to form nitrogen gas N₂, and oxygen gas O₂. The supplied oxygen from the oxygen supply 46 provides oxygen for the reactions. In one specific example, the catalyst includes a TWC with about 100 millimeters (mm) diameter and about 120 mm in length having a honeycomb structure with 20 moles per cubic meter (mol/m³) catalyst loading. It will be appreciated that the catalyst 64 may include other types and amounts of catalyst with other amounts of catalyst loading. In this context, the term “about” is known to those skilled in the art. Alternatively, the term “about” may be read to mean plus or minus 5.0 millimeters.

In another example, the converter 30 has a catalyst 64 including hopcalite, which is active at a low temperature. When hopcalite is used, the hopcalite may be doped with gold (Au) for faster response and better conversion of the flammable gas into inert gas.

In an example, the catalyst 64 may be coated on an inside surface 66 of the converter 30. When the catalyst 64 is coated on the inside surface 66, the catalyst 64 may be a monolith block with a honeycomb structure. In another example, the catalyst 64 may be packed in the converter 30 as pellets forming a packed bed reactor.

Referring still to FIG. 2, the gas scrubber 32 is fluidly and mechanically coupled with the converter 30 and receives the inert gas 62 from the converter 30. The gas scrubber 32 removes and filters harmful and toxic contents of the inert gas that may have survived the catalytic reaction of the flammable gas 38. In an example, the gas scrubber 32 includes a liquid. In this example, the flammable gas 38 contacts the liquid as the inert gas flows through the gas scrubber 32, and at least some of the toxic components within the inert gas 62 pass to the liquid. Inert gas 62 exiting the gas scrubber 32 is then free or substantially free of toxins. It will be appreciated that other types of gas scrubbers may be used to remove toxins from the inert gas.

The fire prevention device 22 and battery pack assembly 12 of the present disclosure is advantageous and beneficial over the prior art. When the battery pack assembly 12 undergoes thermal runaway, flammable and toxic gases are generated. The fire prevention device 22 serves to prevent battery pack assembly fires by converting the flammable gas 38 into inert gas 62 using an oxygen supply 46 and the converter 30 with a catalyst 64 to convert the flammable and toxic gases into inert gases. Additionally, the fire prevention device 22 includes a particulate filter 26 to remove hot ejecta 34, which may be an ignition source, thus reducing fire risk. Further, the inert gas exiting the converter 30 may still include toxic gas. The fire prevention device 22 includes a gas scrubber 32 that is configured to remove the toxic gas.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A fire prevention device, comprising:
a particulate filter configured to receive flammable gas from a battery pack housing and to filter ejecta from the flammable gas exhausted from the battery pack housing;
a mixing chamber fluidly coupled with and configured to receive the flammable gas from the particulate filter, wherein the mixing chamber is fluidly coupled with an oxygen supply;
a converter fluidly coupled with and configured to receive the flammable gas and oxygen from the mixing chamber, wherein the converter includes an oxidation catalyst that converts the flammable gas to an inert gas by a chemical reaction; and
a gas scrubber fluidly coupled with the converter, wherein the fire prevention device is coupled to the battery pack housing.

2. The fire prevention device of claim 1, wherein the particulate filter includes a plurality of channels having channel walls, wherein each channel wall includes a porous material.

3. The fire prevention device of claim 2, wherein the each of the plurality of channels is closed at one of an inlet of the particulate filter or an outlet of the particulate filter, and flammable gas entering a channel closed at the outlet of the particulate filter must flow through a porous wall into a channel closed at the inlet of the particulate filter.

4. The fire prevention device of claim 2, wherein a diameter or a width of the plurality of channels is about one centimeter.

5. The fire prevention device of claim 1, wherein the oxygen supply includes a chemical oxygen generator (COG).

6. The fire prevention device of claim 5, wherein the chemical oxygen generator (COG) includes at least one of a chlorate of alkali metals.

7. The fire prevention device of claim 1, wherein the oxygen supply includes an oxygen tank.

8. The fire prevention device of claim 1, wherein the oxygen supply includes an air multiplier device that draws ambient air using a Coanda effect.

9. The fire prevention device of claim 1, wherein the oxygen supply includes an active device that blows and provides ambient air to the mixing chamber.

10. The fire prevention device of claim 1, wherein the converter includes a surface that is a monolith block with a honeycomb structure.

11. The fire prevention device of claim 1, wherein the converter includes a packed bed reactor.

12. The fire prevention device of claim 1, wherein the oxidation catalyst is coated on at least a portion of the converter.

13. The fire prevention device of claim 1, wherein the oxidation catalyst comprises a three-way catalyst including at least one of platinum or palladium.

14. The fire prevention device of claim 1, wherein the oxidation catalyst comprises hopcalite.

15. A battery pack assembly, comprising:
a fire prevention device coupled to a battery pack housing, the fire prevention device including:
a particulate filter configured to receive flammable gas from the battery pack housing and filter ejecta from the flammable gas;
a converter fluidly coupled with and configured to receive the flammable gas from the particulate filter, wherein the converter includes an oxygen storage catalyst (OSC) that releases oxygen and is an oxidation catalyst that converts the flammable gas to an inert gas by a chemical reaction; and
a gas scrubber fluidly coupled with the converter.

16. The battery pack assembly of claim 15, wherein the particulate filter includes a plurality of channels having channel walls, wherein each channel wall includes a porous material.

17. The battery pack assembly of claim 15, wherein the oxygen storage catalyst (OSC) includes at least one of cerium oxide, perovskite, or hopcalite.

18. The battery pack assembly of claim 15, wherein the oxygen storage catalyst (OSC) includes about 30 grams of cerium oxide.

19. The battery pack assembly of claim 15, wherein the oxygen storage catalyst (OSC) is applied to at least a portion of the converter.

20. A battery pack assembly, comprising:
a fire prevention device coupled to a battery pack housing, the fire prevention device including:
a particulate filter configured to receive flammable gas from the battery pack housing and to filter ejecta from the flammable gas, wherein the particulate filter includes a plurality of channels having channel walls, wherein each channel wall includes a porous material through which the ejecta cannot pass;
a mixing chamber fluidly coupled with and configured to receive the flammable gas from the particulate filter, wherein the mixing chamber is fluidly coupled with a dedicated oxygen supply that supplies oxygen to the flammable gas for converting the flammable gas to an inert gas;
a converter fluidly coupled with and configured to receive the flammable gas from the mixing chamber, wherein the converter includes an oxidation catalyst that converts the flammable gas to an inert gas by a chemical reaction, wherein the converter is about 100 millimeters in diameter and about 120 millimeters in length, and wherein the oxidation catalyst has a honeycomb structure with 20 mol/m³ catalyst loading; and
a gas scrubber fluidly coupled to the converter.
